(19) United States
(12) Patent Application Publication
(10) Pub. No.: US 2012/0217355 A1
(43) Pub. Date: Aug. 30, 2012

(54) OVAL FIR TREE MOUNT

(75) Inventors: GERARD G. GEIGER, Jackson, WI (US); Scott J. Adams, Manomonee Falls, WI (US)

(73) Assignee: Hellermann Tyton Corporation, Milwaukee, WI (US)

(21) Appl. No.: 13/220,308

(22) Filed: Aug. 29, 2011

Related U.S. Application Data
(63) Continuation-in-part of application No. 10/835,864, filed on Apr. 30, 2004, now Pat. No. 8,028,962.

(51) Int. Cl. F16L 3/12; F16L 3/00

(52) U.S. Cl. 248/74.2; 248/65; 248/74.1; 248/74.3

(57) ABSTRACT

Disclosed is an improved mounting and securing device. The device provides for attachment at least one elongate object to a surface and includes a diaphragm spring and an oval fir tree mount. The device is secured to and prevents rotation in an oval or slot shaped hole in a mounting surface. The oval fir tree mount has a tapered tip and a substantially oval shape. Fir tree branches are attached to an oval shaped trunk at various elevations or staggered heights. The diaphragm spring includes a flexible umbrella extending toward the fir tree branches. The diaphragm spring provides tension and resistance when the fir tree mount is inserted into a mount hole formed in a supporting surface such as a panel. The flexible spring combined with the staggered height branches allow the device to be securely retained in different mounting hole thicknesses. The substantially oval configuration prevents rotation.

### RELATED APPLICATIONS

This is a continuation-in-part of co-pending U.S. patent application Ser. No. 10/835,864, filed 30 Apr. 2004.

### BACKGROUND OF THE INVENTION

This invention relates generally to hardware for securing bundled elongate articles, such as wires, cables, hoses, tubing, fiber optics, conduits, vines, etc., to a supporting structure. Also, the invention relates to a fastening element for securing electrical connectors or terminal plugs to mating electrical connectors or terminal plugs.

In many applications, it is sufficient merely to secure the items into a bundle. Such applications might include, for example, stationary electronic equipment that remains in one place and is subject to little or no vibration in use. In other applications, it is necessary or desirable not only to secure the items into a bundle, but to secure and route the resulting bundle to a supporting chassis or framework as well. Such applications are also common, for example, in cars, trucks, airplanes, ships, boats and other vehicles where the bundle is likely to be subjected to severe jostling and vibration. In other applications (e.g. buildings), where vibration might not be an important consideration, it is still desirable to secure and route cables, hoses, tubes, and various components, etc., to a fixed structure.

Further, automobiles and trucks manufactured today feature numerous electronic components provided for the safety, comfort, and convenience of passengers. Many of these features, controls and interface components are located in or near the seats of automobiles; for example, automatic seat position controls, seat heaters, and safety sensors such as seatbelt engagement sensors and weight sensors for engagement of an airbag system. Many other electronic components are located around the engine; for example, the alternator, O₂ sensor (exhaust gas), engine temperature gauge, tachometer, MAP sensor (mass air flow), etc. Other electric components extend around the perimeter of the vehicle such as the lighting. All the electrical/electronic components require electrical wiring and/or wiring harnesses beginning at the power supply (battery) and extending throughout the vehicle to all the electronic components. The electric and electronic components have terminals or electrical connectors which in many instances are on a short pigtail (electrical wires) permanently connected to the electronic component. These terminals or electrical connectors are plugged into the vehicles' wiring harness to the mating electrical connectors or terminal plugs. The electrical connectors or terminal plugs are generally secured to some structure on the vehicle, like the chassis to prevent loose or dangling wires which would otherwise produce undesirable noise or electronic interference/disturbance or become damaged from abrasion or fatigue (moving or vibrating against relatively stationary components or structures). Therefore, it would be desirable to secure the electrical connector or terminal plug in a fixed position.

Many plastic fir tree fasteners do not provide efficient, secure retention features that provide a robust grip when applied to a support surface. Previous fir tree fasteners, such as U.S. Pat. No. 4,396,329 issued to Wollar, contemplates staggered mounting branches, but leaves room for performance improvement. Such fasteners may not provide sufficient retention and tightness against the support surface for adequately supporting a bundled item. Likewise, such fasteners may utilize a longer than necessary mounting stud and may not be easily inserted into the support surface. Additionally, many fasteners do not provide for anti-rotation when applied to a support surface, or require more than one mounting shaft to prevent rotation (see FIGS. 21A and 21B). The present invention provides for an improved performance, securing and routing fastener to address these problems.

### SUMMARY OF THE INVENTION

The present invention provides an improved securing and routing oval fir tree mount or fastener to retain and orient cables, hoses, tubes, and various components, etc., to a mounting surface or structure. The oval fir tree mount secures the aforementioned components in a specific direction/orientation because the oval trunk segment and fir tree branches closely fit and mate with an oval or slot shaped mounting hole thereby not allowing the oval fir tree mount to rotate in the oval or slot shaped mounting hole. Further, branches extend from all sides of the oval center trunk segment of the mounting section at staggered elevations. The staggered branch pattern provides alternate and more frequent engagements thereby gripping uniformly onto various thicknesses of selected mounting surfaces. The thin, steeply angled branches easily flex to pass through the oval, rectangular or slot shaped mounting hole in the supporting surface providing low insertion force; then the branches spring back to engage the backside of the supporting surface to retain the oval fir tree fastener in the oval, rectangular or slot shaped mounting hole.

The invention preferably also include a flexible diaphragm spring which conforms to the supporting surface and provides tension and resistance when the oval fir tree fastener or mount is inserted into the mounting hole in the supporting surface. The invention may also include a connector and latch to attach the oval fir tree fastener to a wire connector or wire terminal. The invention may also include a clip or clamp to connect at least one wire or other elongate object to the oval fir tree fastener. The invention may also include a saddle with an aperture to receive a cable tie, optionally secured around a bundle of objects, to the oval fir tree fastener. The invention may also include a tape clip or a cable tie formed integrally with the oval fir tree fastener. An oval fir tree fastener according to the present invention may include any combination of the above features.

### BRIEF DESCRIPTION OF THE DRAWINGS

FIG. 1 is a perspective view of the oval fir tree fastener or mount of the present invention.

FIG. 2 is a front elevation view of the oval fir tree fastener of the present invention.

FIG. 3 is a side elevation view of the oval fir tree fastener of the present invention. FIG. 3A is a cross sectional view of the oval fir tree fastener, taken along the line 3A-3A in FIG. 2.

FIG. 4 is a cross sectional view of the oval fir tree fastener, taken along the line 4-4 in FIG. 2.

FIG. 4A is a cross sectional view of the oval fir tree fastener, taken along line 4A-4A in FIG. 3.

FIG. 5 is a side elevation view of the oval fir tree fastener of the present invention engaged within the channel of a wire connector.

FIG. 6 is a perspective view of the oval fir tree fastener of the present invention aligned for engagement with the wire connector.

FIG. 7 is a perspective view of the oval fir tree fastener of the present invention aligned and partially inserted, engaging with the wire connector.

FIG. 8 is a perspective view of the oval fir tree fastener of the present invention fully inserted and snapped into engagement with the wire connector.

FIG. 9 is a side elevation view of the oval fir tree fastener of the present invention lined up to be inserted into an aperture in a panel.

FIG. 10 is a side elevation view of the oval fir tree fastener of the present invention inserted into an aperture in a panel.

FIGS. 11-20 depict different embodiments of an oval fir tree fastener of the present invention.

FIGS. 21A and 21B are exemplary prior art fir tree fasteners.

### DESCRIPTION OF THE PREFERRED EMBODIMENT

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention, which is defined by the claims.

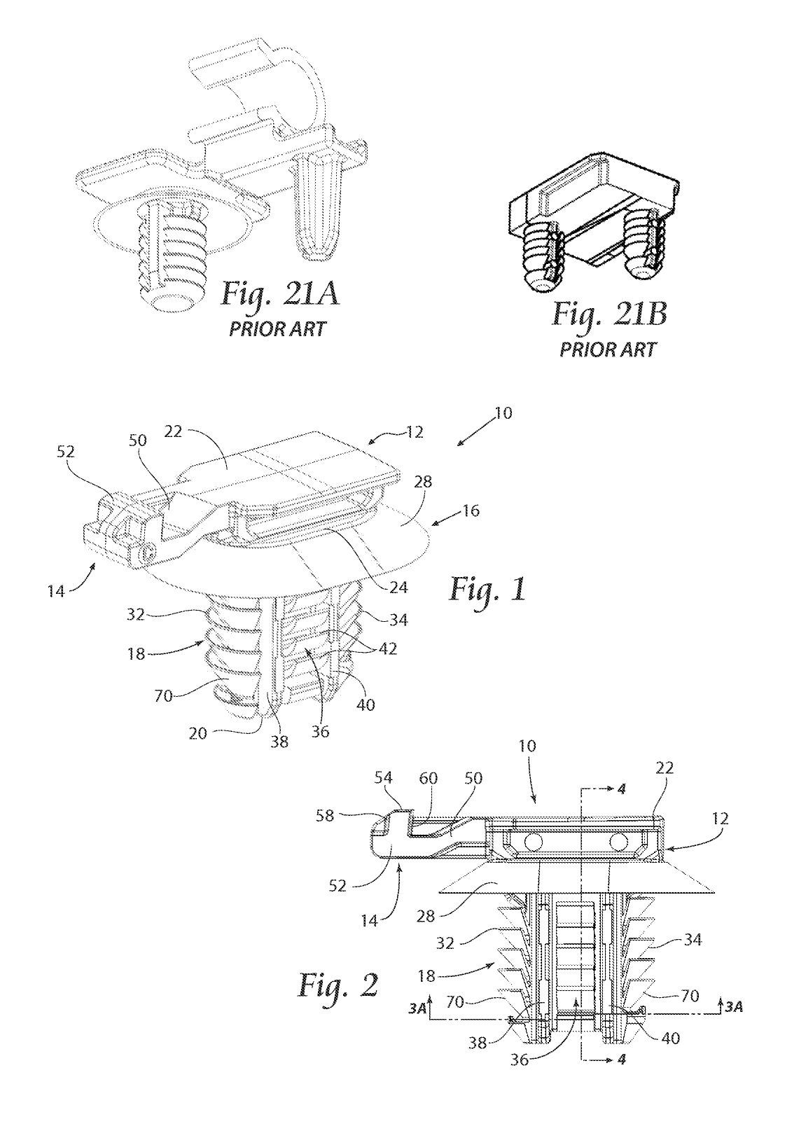

FIGS. 1-4 show an oval fir tree fastener 10 according to the present invention. The oval fir tree fastener 10 of the preferred embodiment comprises a connector 12, a latch 14, a diaphragm spring 16, and an oval fir tree 18 ending in a tapered, conical, oval leading tip 20. The connector 12 has a generally I-beam shaped cross section. The horizontal I-beam shaped section is comprised of an upper flange which serves as a mounting plate 22, a lower flange which is the mid base 24, and a web section 26.

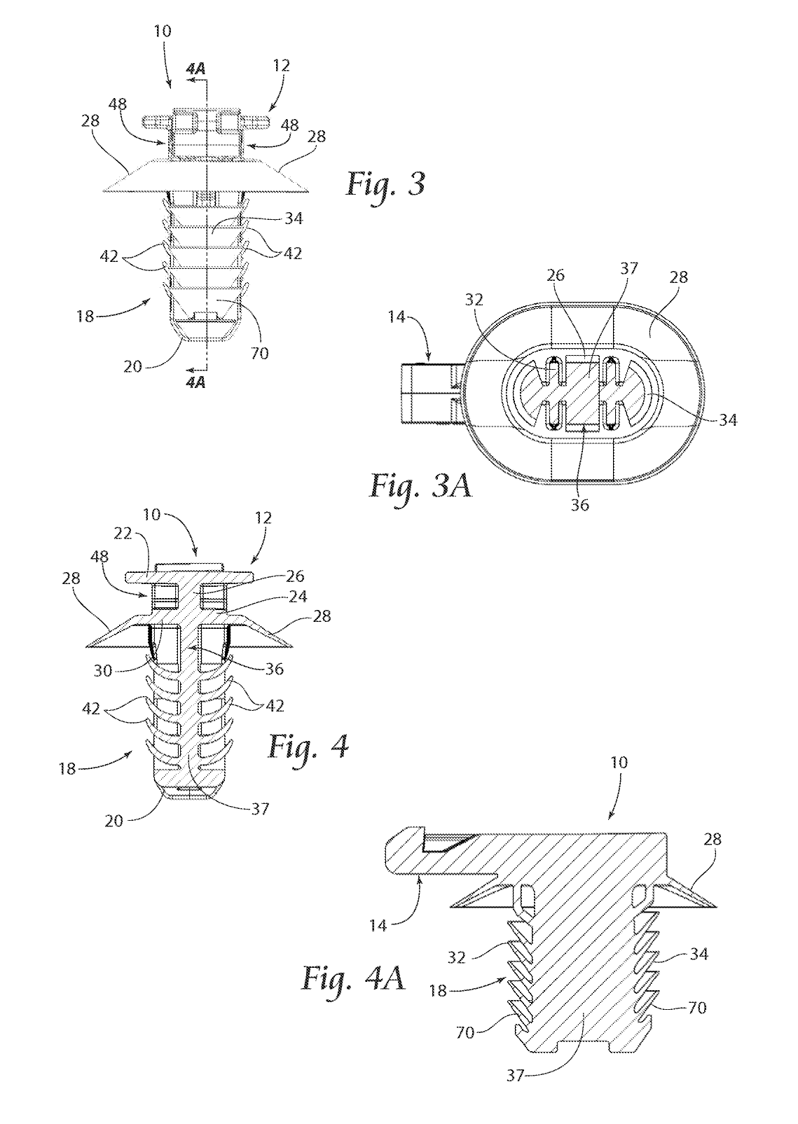

A diaphragm spring 16 is comprised of a flexible umbrella 28 which emanates from the mid base 24 by an oval support 30. The oval support 30 is parallel to the mid base 24. The flexible umbrella 28 has a generally oval conic shape whereby the spring 28 is angled and extends downward toward the tapered leading tip 20 of the oval fir tree fastener 10, best seen in FIGS. 3 and 4. The flexible umbrella 28 is also tapered (thinner cross section) at the free end thereof, to increase the range of flexibility of the spring 28.

Extending beneath the oval support 30 is the oval fir tree 18 which is best seen in FIGS. 1, 2, 3, and 4. The oval fir tree 18 consists of a first conic branch section 32, a similar second conic branch section 34, and a central branch section 36—all forming an oval shaped section or trunk. FIG. 3A is a cross section view taken from line 3A-3A in FIG. 2. FIG. 3A depicts the oval shaped section of the first and second conic branch sections 32 and 34, along with the central branch section 36. The central branch section 36 spans between the first and second conic branch sections 32 and 34 such that the vertical plane of the central branch section 36 is generally perpendicular to the vertical plane of the first and second conic branch sections 32 and 34.

The first and second conic branch sections 32 and 34 each have a plurality of conic branches 70 as shown in FIG. 4A. Conic branches 70 are disposed such that their free ends are angled toward the connector 12. As best shown in FIG. 4A, each branch 70 is further tapered at its free end to form a leading tip 20. The leading tip 20 is tapered (thinner cross section) to aid in insertion of the fastener 10 in a mounting aperture 44 in a supporting panel. The thinner cross section flexes easier and lowers insertion force.

The central branch section 36 is defined by a first rib 38 and a second rib 40 with a plurality of curved branches 42 attached to the central spine 37, and formed between ribs 38, 40. As can be seen in FIG. 4, the free ends of the branches 42 are curved toward the connector 12, and each branch 42 is also tapered at its free end. Ribs 38 and 40 are substantially parallel to one another.

Referring again to FIGS. 1-4, the latch 14 extends from the mounting plate 22. The latch 14 comprises a snap beam 50 and a snap hook 52. The snap beam 50 is a flexible generally rectangular arm which extends perpendicularly from the mounting plate 22 at generally the same location as the notches 48. A snap hook 52 is formed at the free end of the snap beam 50. The snap hook 52 extends from the top surface of the snap beam 50. In the preferred embodiment, the top surface 54 is generally parallel to the snap beam 50. As is best seen in FIG. 2, the leading surface 58 of the snap hook 52 slopes from the tip of the snap beam 50 back towards the connector 12. The trailing surface 60 is also sloped to provide increased retention, although the trailing surface 60 is closer to perpendicular to the snap beam 50 than the leading surface 58.

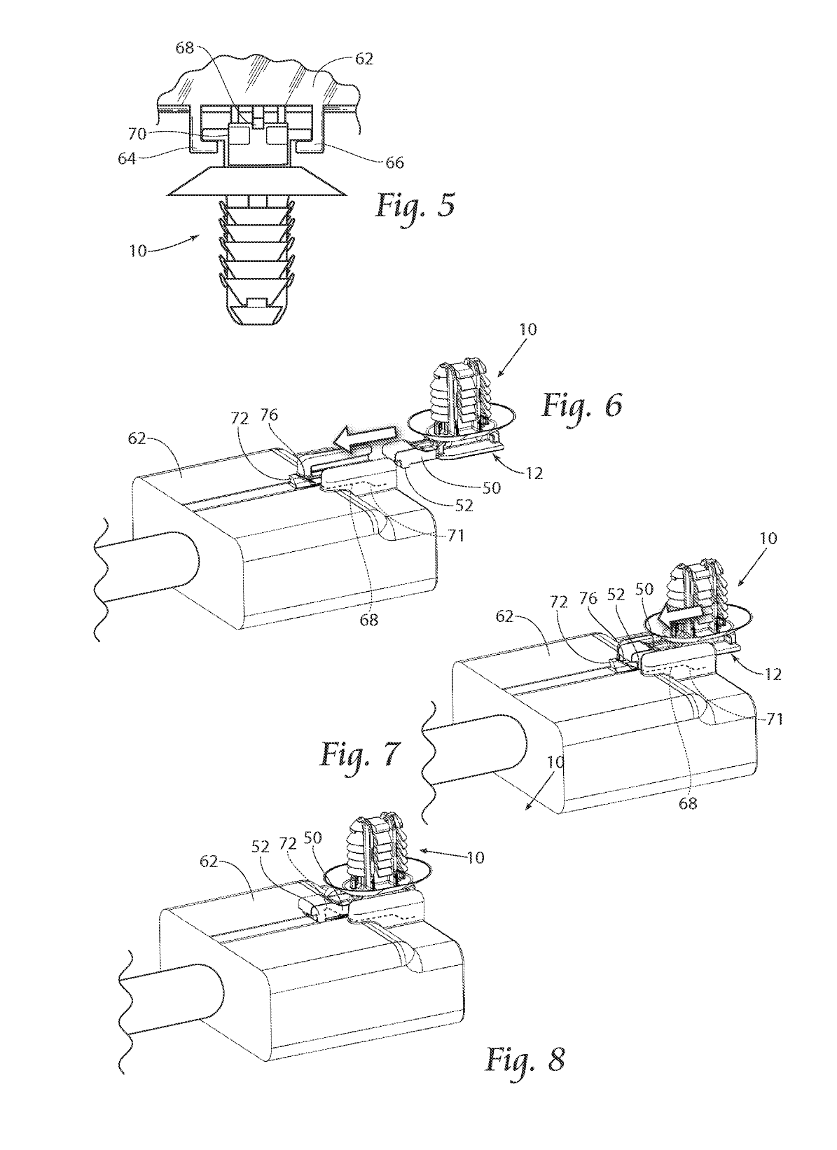

The oval fir tree fastener 10 is designed to be easily attached to a wire connector 62. To achieve this, the wire connector 62 is formed with a plurality of raised segments. As shown in FIG. 5, the connector 62 has at least two angle segments and a raised segment. The first angle segment 64 and the second angle segment 66 are each formed as a right angle. The first angle segment 64 and the second angle segment 66 each have a portion which extends perpendicularly from the connector 62 and a portion which is horizontal to the connector 62. The first angle segment 64 and the second angle segment 66 are oriented such that the two segments 64, 66 form a slot 70 into which the oval fir tree fastener 10 connector 12 can slide.

The raised segment 68 is best shown in FIGS. 5, 6 and 7. The raised segment 68 is generally oval. The raised segment 68 has a leading end 71 and an abutment face 72. The leading end 71 is formed as a first ramped portion that extends from the surface of the connector 62 to the surface of the raised segment 68. At the trailing end the raised segment 68 has a second ramped surface 76. The raised segment 68 ends in an abutment face 72 which is somewhat perpendicular to the connector 62.

As is shown in FIGS. 6-8, the oval fir tree fastener 10 can be attached to the wire connector 62 by aligning the oval fir tree fastener 10 with the slot 70 on the wire connector 62. The oval fir tree fastener 10 is then slid into the slot 70. The horizontal portion of the first angle segment 64 and the second angle segment 66 engage the groove formed on the connector 12 of the oval fir tree fastener 10. The top surface 54 of the snap hook 52 slides along the surface of the raised segment 68. When the snap hook 52 reaches the trailing end 73 of the raised segment 68, the leading surface 58 of the snap hook 52 engages the second ramped surface 76 of the raised segment 68. The second ramped surface 76 acts as a cam surface, so that as the oval fir tree fastener 10 is slid further into the slot 70 the snap hook 52 continues to slide along the second ramped surface 76 and the snap beam 50 is caused to flex as shown in FIG. 7. As the snap hook 52 passes the end of the second ramped surface 76, the snap beam 50 springs back to its original unflexed position. The oval fir tree fastener 10 cannot be slid out of the slot 70 in the wire connector 62 because of the engagement of the trailing surface 60 of the snap hook 52 with the abutment end 72 of the raised segment 68. The wire connector 62 and the oval fir tree fastener 10 are thereby interlocked. However, to disengage the oval fir tree fastener 10 from the wire connector 62, the snap hook 52 can be manually lifted out of engagement with the abutment end 72 and the oval fir tree fastener 10 can be slid from the slot 70 in the wire connector 62.

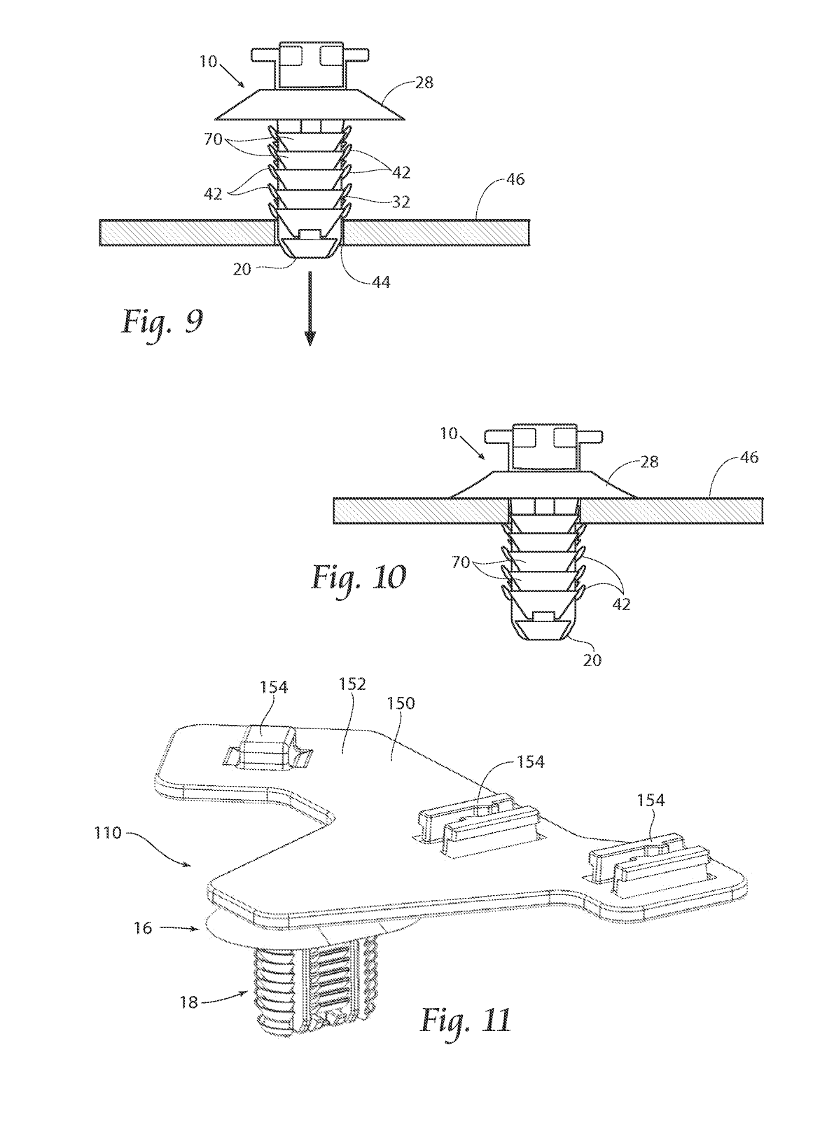

FIGS. 9 and 10 show how the oval fir tree fastener 10 of the present invention is inserted into a mounting aperture 44 in a supporting panel 46. The fastener 10 is shown without the wire connector 62 being attached to aid in the clarity of the figures. However, it should be understood that the oval fir tree fastener 10 can be inserted into a mounting aperture 44 with or without the wire connector 62 attached to the oval fir tree fastener 10. The tapered leading tip 20 of the oval fir tree fastener 10 is lined up with the mounting aperture 44 in the panel 46 as seen in FIG. 9. The leading tip 20 is inserted into the mounting aperture 44. When the oval fir tree fastener 10 is pushed further into the aperture 44, the branches 42 and 70 flex and are wedged into the inner surface of the oval aperture 44. The branches 42 and 70 then spring back to their original configuration after they exit the mounting aperture 44. The branches 42 and 70 substantially grip the entire circumference of the opening or aperture 44.

When the oval fir tree fastener 10 is securely inserted into a mounting aperture 44, the free ends of sets of branches 42 and 70 will engage the backside of the panel 46. The ends of the flexible diaphragm umbrella spring 28 engage the supporting panel 46 when the oval fir tree fastener 10 is completely inserted into a mounting aperture 44 in the panel 46. The flexible umbrella 28 of diaphragm spring 16 applies a preload pressure to the top of the supporting surface 46 which stabilizes the oval fir tree fastener 10 and the attached wire harness 62. The oval fir tree fastener 10 is securely retained in the aperture 44 by the ends of the branches 42 and 70 engaging the backside of the panel 46, and the flexible umbrella 28 of the diaphragm spring 16 engaging the opposite side of the panel 46.

The flexibility of the spring 16 allows it to be utilized on a variety of panel 46 thicknesses. The force applied by the spring 16 prevents the oval fir tree fastener 10 and attached wire harness 62 from being unstable on varying panel thicknesses. The plurality of branches 42 and 70 on the oval fir tree fastener 10 also allows for variety of panel thicknesses to be accommodated. Further, the branches 70 of the first conic branch section 32 and the second conic branch section 34 form the composite oval shape and each makes contact with the oval mounting aperture to also provide anti-rotation.

The use of an oval fir tree fastener 10 has several advantages over other possible means of securing a connector. The oval fir tree fastener engages a large range of panel thicknesses from approximately 0.7 millimeters to 18 millimeters which can be increased or decreased by changing length of the fir tree 18 and changing the number of branches in branch sections 32 and 34. The oval fir tree fastener 10 has a low insertion force which is below 10 lbs. The oval fir tree fastener 10 has a high retention force which is above 60 lbs. in some configurations and above 100 lbs. in other configurations. Only a single oval mounting hole 44 is required to achieve anti-rotation of the device 10. Prior art circular fir tree fastener configurations would require at least two holes to achieve anti-rotation. For example, FIG. 21A depicts a prior art fir tree fastener having a traditional round fir tree fastener and a second post to achieve anti-rotation. Similarly, the prior art fir tree fastener shown in FIG. 21B employs two traditional fir tree fasteners to provide for anti-rotation. The single mounting hole 44 utilized by the present invention requires less space than a two hole configuration. The single oval fir tree fastener 10 is easier to align and push in to the oval mounting hole 44 than an alternate configuration which would require at least two mounting holes or mounting retainers or fasteners. It is also important to note that oval mounting holes 44 are a preferred stamping or punch out pattern versus the formation of two round holes or a rectangular hole.

It is clear that the present invention could be manufactured by various methods, and of various materials. Preferably the fastening device is injection molded from a strong, durable plastic, such as Nylon 6/6.

Although the preferred application is for use in an automobile or truck, it should be understood that the invention could also be utilized in many different devices including, but not limited to other vehicles such as airplanes and boats, or in computer equipment, consumer electronics devices, communication devices, and medical instruments and devices. The invention can generally be applied to any application where a bundle of elongate articles are desired to be secured without rotation to a rigid supporting structure. Additionally, although the preferred embodiment described a wire connector 62, the oval fir tree fastener 10 could be attached to any type of device which could be formed on the bottom segment 24.

An alternate embodiment of the oval fir tree fastener 110 is shown in FIG. 11. The embodiment shown in FIG. 11 is similar to the preferred embodiment; however, the connector section 150 has a different configuration. The connector section 150 includes a larger mounting plate 152 which extends generally perpendicularly from the bottom segment 24 at generally the same location as the mounting plate 22 of the embodiment shown in the previous figures. The large mounting plate 152 has multiple latch structures 154 formed on its top surface.

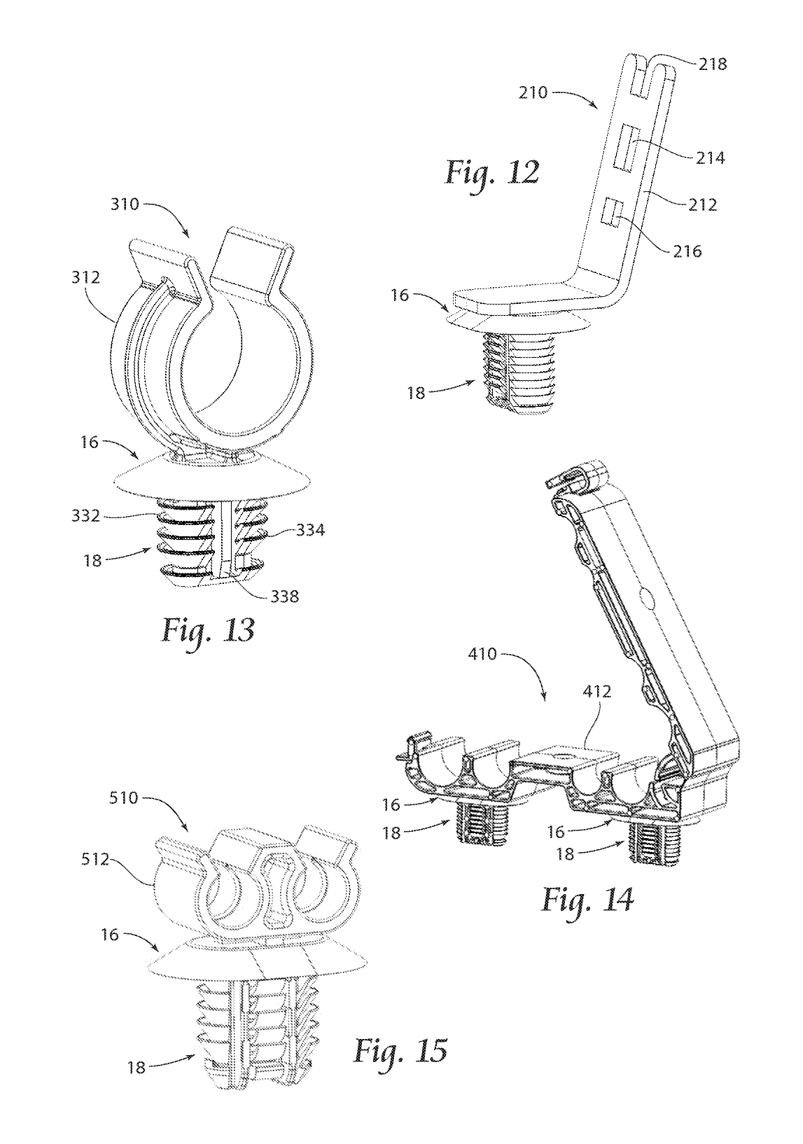

An alternate embodiment of the oval fir tree fastener 210 is shown in FIG. 12. The embodiment shown in FIG. 12 is similar to the preferred embodiment; however the connector 212 is a relatively straight beam 214 having openings 216 and a notch 218. The beam 214 is formed at an angle relative to the mounting plate 22.

FIGS. 13-20 are further examples of the features of the present invention used in different embodiments. The embodiments of FIGS. 13-20 employ the diaphragm spring 16 and oval fir tree 18 as described above. The embodiments of FIGS. 13-20 are not adapted to be attached to a wire connector; rather these embodiments are designed to attach to a bundle or at least one elongate item. Therefore, the embodiments of FIGS. 13-20 do not include the connectors and latches described above. Each of the embodiments of FIGS. 13-20 utilizes a different type of device to attach the at least one elongate item to the oval fir tree fastener. The additional embodiments of the oval fir tree fastener are attached to a panel 46 as described above with respect to the preferred embodiment.

The first conic branch section 332 and second conic branch section 334 of oval fir tree 18 in the embodiment shown in FIG. 13 has a slightly different configuration than that of the preferred embodiment 10. The embodiment of FIG. 13 does not include the central branch section 36, but all the branches attach to the central spine 37. Therefore, the first conic branch section 332 and the second conic branch section 334 extend along the width of the oval fir tree 18 to meet at a single rib 338. The first conic branch section 332, second conic branch section 334 and rib 338 form a modified composite oval branch structure of the oval fir tree fastener.

FIG. 13 further shows an oval fir tree fastener 310 of the present invention employing the diaphragm spring 16 and oval fir tree 18 as described above. The connector and latch have been replaced by a clamp 312. The clamp 312 extends from the bottom segment 24. The clamp 312 may retain items of various diameters, including a single item of a larger diameter or a bundle of items with smaller diameters.

FIG. 14 shows an oval fir tree fastener 410 of the present invention employing the diaphragm spring 16 and oval fir tree 18 as described above. In the present embodiment the connector and latch have been replaced by a hinged clip 412. The clip 412 extends from the bottom segment 24, and is adapted to be clipped around multiple elongate items such as a wires, cables, hoses, tubing, harnesses, etc.

FIG. 15 shows an oval fir tree fastener 510 of the present invention employing the diaphragm spring 16 and oval fir tree 18 as described above. In the present embodiment the connector and latch have been replaced by a double clamp 512.

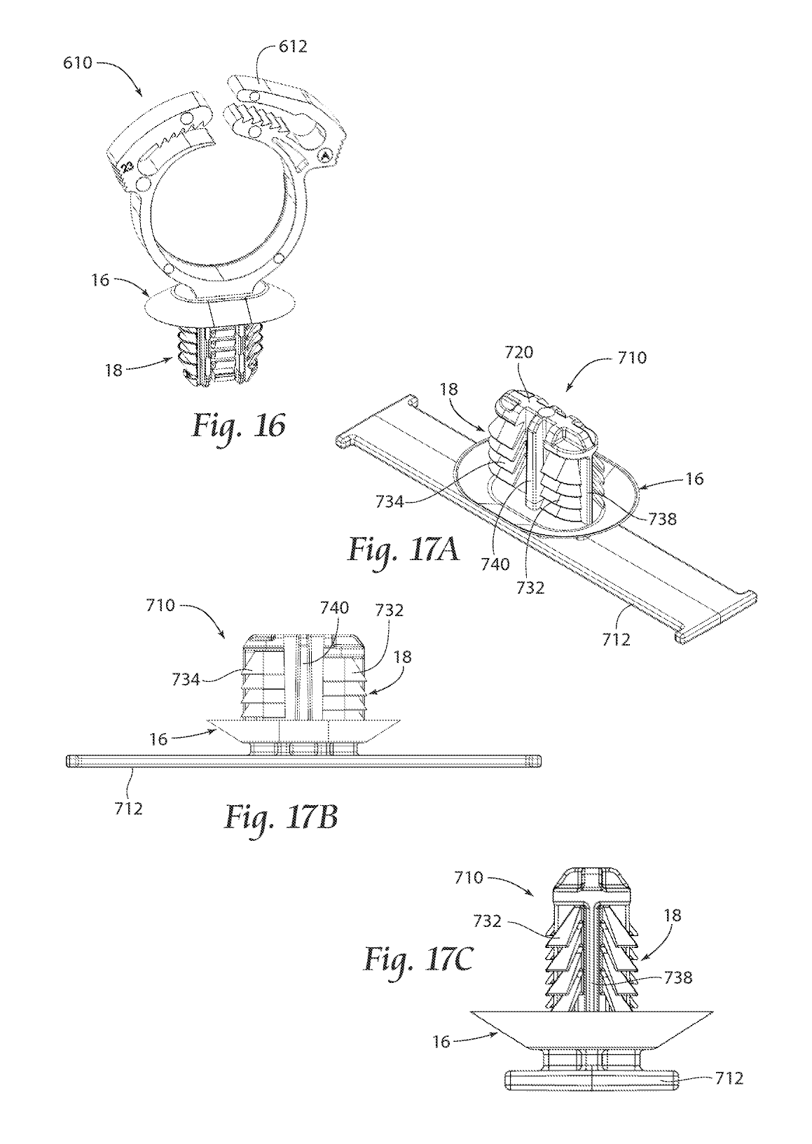

FIG. 16 shows an oval fir tree fastener 610 of the present invention employing the diaphragm spring 16 and oval fir tree 18 as described above. In the present embodiment the connector and latch have been replaced by a clamp 612. The clamp 612 extends from the bottom segment 24. The clamp 612 may be tightened around items of various diameters, including a single item of a large diameter or a bundle of items with smaller diameters.

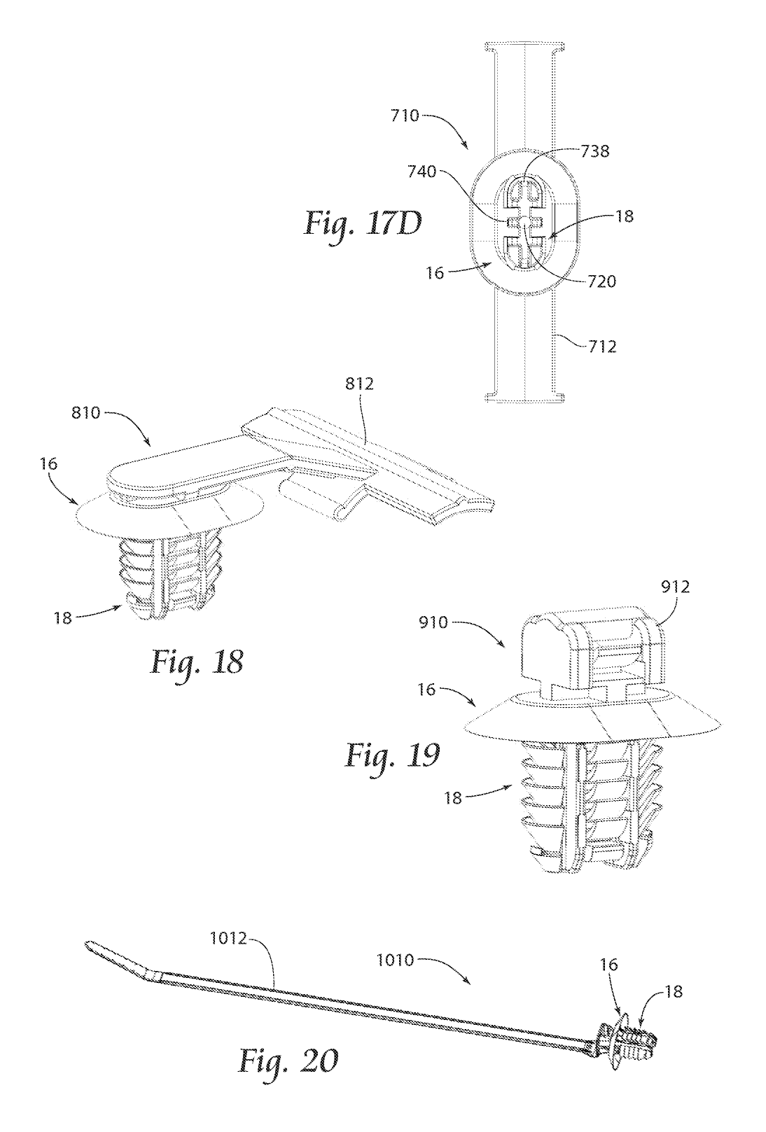

The first conic branch section 732 and second conic branch section 734 of oval fir tree 18 in the embodiment shown in FIGS. 17A-17D has a slightly different configuration than that of the preferred embodiment. The embodiment of FIGS. 17A-17D is similar to the fastener shown in FIG. 13. However, first and second ribs 738, 740 are generally orthogonal to each other and divide the first conic branch section 332 and the second conic branch section 334 as shown. Ribs 738 and 740 intersect one another at a generally right angle at the leading tip 720.

FIGS. 17A-17D further show an alternate embodiment of the oval fir tree fastener 710 of the present invention employing the diaphragm spring 16 as described above. In the present embodiment the connector and latch have been replaced by a straight tape clip 712

FIG. 18 shows an oval fir tree fastener 810 of the present invention employing the diaphragm spring 16 and oval fir tree 18 as described above. In the present embodiment the connector and latch have been replaced by an offset tape clip 812

FIG. 19 shows an oval fir tree fastener 910 of the present invention employing the diaphragm spring 16 and oval fir tree 18 as described above. In the present embodiment the connector and latch have been replaced by a saddle mount 912 for a cable tie.

FIG. 20 shows an oval fir tree fastener 1010 of the present invention employing the diaphragm spring 16 and oval fir tree 18 as described above. In the present embodiment the connector and latch have been replaced by a cable tie 1012 having its neck portion bent at approximately ninety degrees. A straight cable tie could be integrally formed with the oval fir tree fastener as well.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention, which is defined by the claims.

I claim:

1. An integrally formed mount for anchoring at least one elongate member to a support structure, said mounting assembly comprising:
an attachment section;
a spring section integrally formed to said attachment section;
a mounting section integrally formed to said spring section;
said mounting section having a plurality of branches extending there from, said branches being disposed in a substantially oval configuration.

2. The mount of claim 1 further comprising a central section depending from said spring section and a pair of branch sections, each branch section oppositely disposed with respect to said central section, said branches depending from said center segment and said branch sections outward toward respective free ends.

3. The mount of claim 2 wherein said branches curve toward said spring section.

4. The mounting assembly of claim 3 wherein said branches are tapered to their respective free ends.

5. The mount of claim 2 wherein said attachment section further comprises a mounting plate, a bottom segment, and a cross segment, said cross segment extending between said mounting plate and said center segment.

6. The mount of claim 5 wherein said cross segment is substantially perpendicular to said mounting plate and said center segment.

7. The mount of claim 1 wherein said mounting section further comprise a first section, a second section and a center section, said first and second sections being coupled to said center section.

8. The mount of claim 7 wherein said branches on said first section, said branches on said second section and said branches on said center section form a substantially oval branch configuration.

9. The mount of claim 8 wherein said branches on said first section, said branches on said second section and said branches on said center section curve toward said spring section.

10. The mount of claim 9 wherein said branches are tapered at the free end thereof.

11. The mount of claim 1 wherein said mounting section further comprises a central branch section and two conic branch sections, said branches being disposed about said sections.

12. The mount of claim 1 wherein said mounting section further comprises a front end segment, a back end segment, and a center segment, wherein said center segment extends between the front end segment and the back end segment.

13. The mount of claim 12 wherein said center section further comprises a first surface and a second surface, wherein a plurality of branches are formed on each of said first and second surfaces, said plurality of branches extending outwardly from said center section.

14. The mount of claim 13 wherein said front end segment further comprises a front end surface and wherein a plurality of branches are formed on said front end surface.

15. The mount of claim 14 wherein said back end segment further comprises a back end surface and wherein a plurality of branches are formed on said back end surface.

16. The mount of claim 15 wherein each of said plurality of branches is curved towards the attachment section.

17. The mount of claim 15 wherein each of the plurality of branches has a curved free end and is tapered at the free end.

18. The mount of claim 1 wherein said mounting section further comprises a clamp.

19. The mount of claim 1 wherein said mounting section further comprises a clip.

20. The mount of claim 1 wherein said mounting section further comprises a cable tie.
